(19) United States
(12) Patent Application Publication
(10) Pub. No.: US 2026/0236276 A1
(43) Pub. Date: Aug. 13, 2026

(54) SYSTEMS AND METHODS FOR CONVERSATION ANALYSIS

(71) Applicant: WELLS FARGO BANK, N.A., San Francisco, CA (US)

(72) Inventors: Paul Polyak, Brooklyn, NY (US); Giles Richardson, Mercer Island, WA (US); Jeffrey Rothbard, Metuchen, NJ (US); Yair Zajid Alonzo Montufar, New York City, NY (US); Parvathi Meyyappan, Philadelphia, PA (US)

(73) Assignee: WELLS FARGO BANK, N.A., San Francisco, CA (US)

(21) Appl. No.: 19/407,269

(22) Filed: Dec. 3, 2025

Related U.S. Application Data
(60) Provisional application No. 63/757,262, filed on Feb. 11, 2025.

(51) Int. Cl. G06F 9/451

(52) U.S. Cl. CPC G06F 9/451

(57) ABSTRACT

In certain examples, a method is described that may involve transmitting a set of conversations. For each conversation within this set, the method may include tracking a series of display metrics associated with each conversation, storing these metrics, and pairing each conversation with another. The method can further involve generating a win-rate metric for each pair of conversations, using the stored display metrics as a basis. Additionally, the method may include receiving a selection of a particular conversation from the set and subsequently retrieving a group of metrics related to the selected conversation. The group of metrics can include the win-rate metric for both the selected conversation and its paired conversation. The method may include transmitting a display signal that corresponds to the retrieved set of conversation metrics.

### CROSS-REFERENCE TO RELATED APPLICATIONS

This application claims priority to U.S. Provisional Patent Application No. 63/757,262, filed on Feb. 11, 2025, and entitled “SYSTEMS AND METHODS FOR CONVERSATION ANALYSIS,” the entirety of which is hereby incorporated by reference herein.

### FIELD OF INVENTION

The present disclosure generally relates to machine learning models, and more specifically to systems and methods for message display analysis, also referred to as conversation analysis.

### BACKGROUND

Intelligent user-interfaces and corresponding databases are premised on being reactive to user inputs to foster user engagement. For instance, such user-interfaces can record and track users'engagement with “conversations” where such conversations include push notifications, prompts, banner displays, emails, and other messages transmitted to and displayed to users. Selection of conversations for presentment to a user itself can be a complex task. For instance, designers and developers of user interfaces may want to provide several types of conversations to a user. The designers and developers may however be practically limited in the number of conversations that can be presented to the user. Conversation selection is often obscured by underlying conversation selection algorithms which can lack transparency, rendering it difficult to ascertain why a given conversation was chosen for presentment over another.

### SUMMARY

According to certain examples, a method is described. The method includes transmitting a set of conversations. For each conversation, the method includes tracking a set of display metrics associated with the conversation and storing the set of display metrics. The method includes pairing each conversation with another conversation and generating a win-rate metric for the conversation pair based on the set of display metrics for each conversation. The method includes receiving a selection of a first conversation within the set of conversations and retrieving a set of display metrics associated with the first conversation, where the set of conversation metrics includes the win-rate metric for the first conversation and a second conversation. The method further includes transmitting a display signal associated with the set of display metrics.

Certain aspects of the present disclosure involve systems and non-transitory computer-readable mediums having instructions stored thereon for executing the method described above.

These illustrative aspects are mentioned not to limit or define the disclosure, but to provide examples to aid understanding thereof. Additional aspects are discussed in the Detailed Description, and further description is provided there.

### BRIEF DESCRIPTION

A full and enabling disclosure is set forth more particularly in the remainder of the specification. The specification makes reference to the following appended figures.

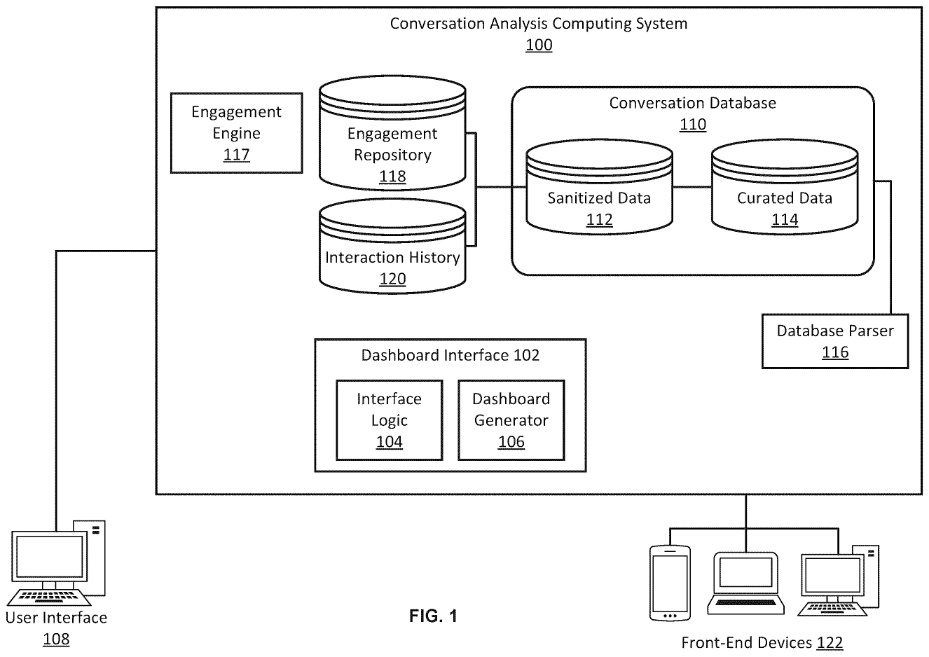

FIG. 1 illustrates a system for analyzing conversations and outputting display signals associated with conversation analysis, according to certain examples.

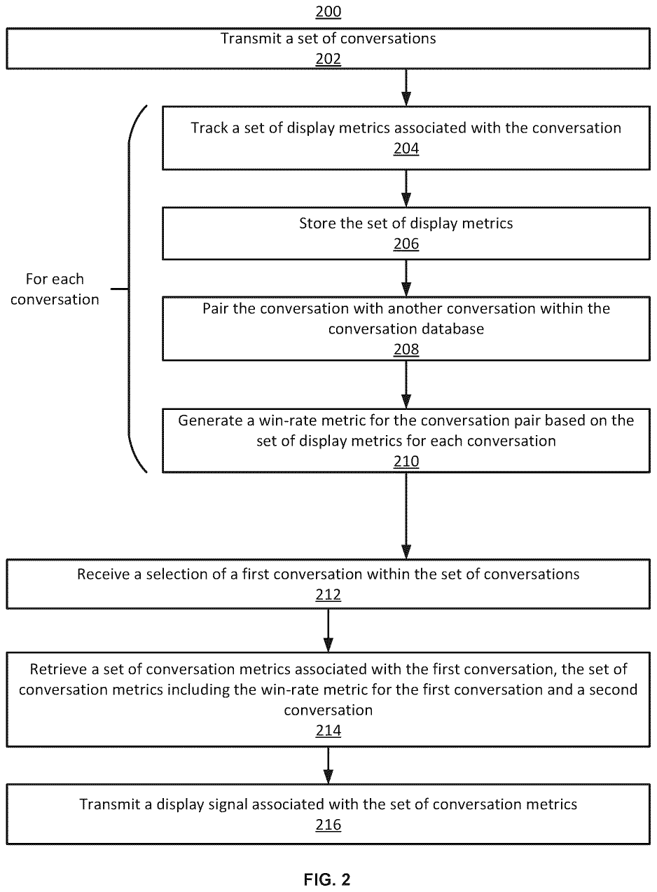

FIG. 2 shows a process for generating metrics for conversation analysis, according to certain examples.

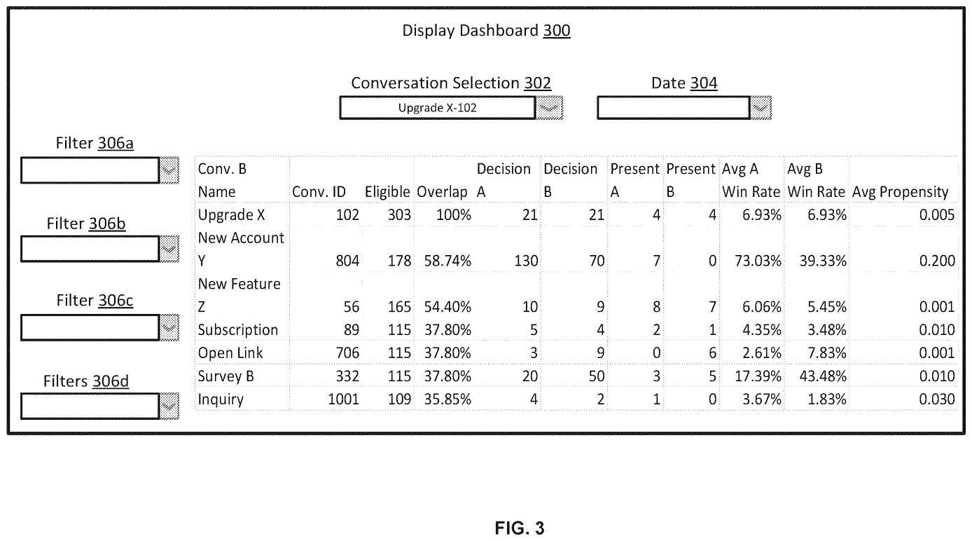

FIGS. 3-7 show various interfaces for allowing conversation analysis, according to certain examples.

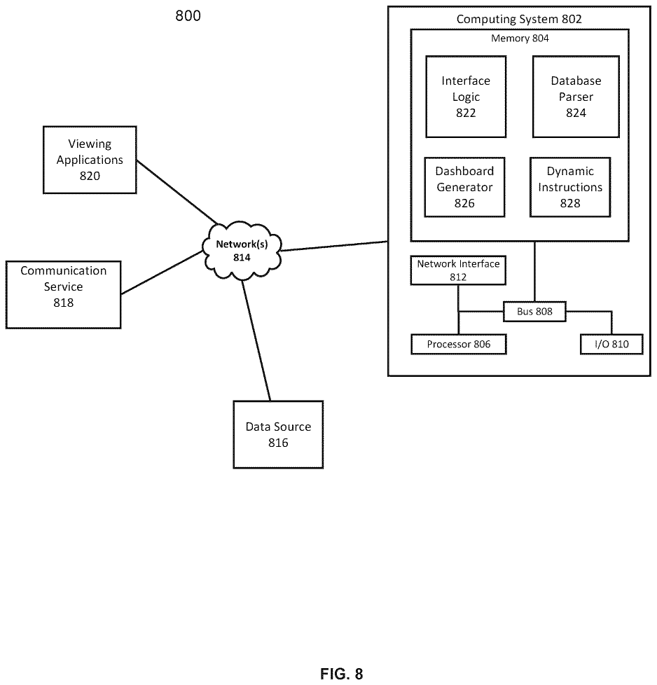

FIG. 8 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of any appended claims and their equivalents.

### Illustrative Example of a Conversation Selection Analysis System

In one illustrative example, a conversation selection analysis system (also referred to as a conversation analysis system) is described, providing useful techniques for explaining, among a database full of candidate conversations to present to users, why a given, selected conversation was chosen for presentment on a user interface over another conversation. In some examples, the analysis can include a pair-wise analysis between two conversations, the analysis further including a “win-rate” which indicates, among the pair of conversations, the rate that one conversation is selected for presentment over other conversations.

The described conversation analysis system includes means for analysis and for presentment of a given conversation which may or may not have been presented to a front-end user. In such a way, back-end users such as developers or “owners” of a given conversation can investigate why the given conversation may or may not have been selected for presentment to a user. Presentment to a user, like conversations, accounts for the various ways in which developers and interface managers look to interactively communicate with front end users. For instance, presentment of conversations can take the form of push notifications, banner displays, emails, pop-ups, and the like.

Data captured by the conversation selection analysis system can include audience headroom and the drivers of “win-rate” or the rate at which a given conversation is selected for presentment over another conversation. Some of the factors, or drivers, of win-rate can be analyzed, and displayed. The displayed factors can include: overlap indicating each conversation competing in a specific placement, further indicative of overlapped audiences; ranking, showing visibility into a given ranking formula including factors such as propensity, strategic weights, and financial value; and audience analysis, where user IDs are isolated to identify which conversations are selected for presentment over others with respect to given users or sets of users, informing developers of potential improvements to target audience definitions. Additional example interfaces (e.g., with respect to FIGS. 3-7) provide different perspectives and means for analyzing conversations to determine the causes of their resulting win-rates, or other indicia of favored and disfavored conversations with respect to presentment.

### Benefits of a Conversation Selection Analysis System

The described conversation selection analysis system can provide a variety of benefits, particularly when paired with a dashboard for presentment to developers and other back-end users. For instance, the conversation selection analysis system provides unique partitions and formulas that can capture analyses related to competing conversations. Back end users can then analyze performance against each conversation using the described win-rate and overlap formulas.

Another benefit comes in the form of reduced manual labor in analyzing conversations. Agents, crawlers, scrapers, monitors and the like are initially configured to gather data related to each conversation presented across each device. Tracking and recording conversation metadata can quickly amount to significant volumes of data (e.g., over hundreds of millions of rows of data per day). The described conversation selection analysis system reduces the need for manual analysis of the raw, high volume data, allowing back-end users, developers and other stakeholders to quickly access and drill down insights for decision making. The described dashboards and navigation menus can allow stakeholders to quickly identify areas for improvement through review of the conversation metrics and visualizations as generated by the conversation selection analysis system. Particularly, the conversations selection analysis system is able to parse raw data which is otherwise hard to understand and generate a final output that is easily interpretable for back end users.

The conversations selection analysis system, as described, includes a variety of filters to provide varying levels of analysis, from high level, quick overview analysis, to drilled down, fine-detailed analysis as requested by a back-end user. Examples of such filters can include channel, page name, placement, slot number, propensity decile, test group, user segmentation, account indicators, and the like. As will be described, additional filters and categories for analysis can be included as inputs for selection and analysis through the described systems and methods.

Example use cases of the analyses presented according to the variety of dashboards described herein include: 1) improve eligibility analysis allowing for identification of target audiences for individual conversations; 2) reach evaluation by measuring the effectiveness of outreach to eligible audiences; 3) audience planning by analyzing overlap across various sectors or conversations; and 4) win-rate evaluation, allowing users to evaluate the effectiveness and strategic trade-offs of given conversations. Additional use cases and benefits of the described example conversation analysis system are contemplated according to the various subsequently described examples.

### Example Computing System for Conversation Analysis

FIG. 1 illustrates a system for analyzing conversations and outputting display signals associated with conversation analysis, according to certain examples. The examples according to FIG. 1 are shown to illustrate the logical and physical implementation of the conversation analysis computing system 100. Other examples, however, are possible. For instance, certain components may be shown as distinct components to illustrate the progression of the data flow, while according to some examples, the physical implementation of such components may be implemented across the same device.

A conversation analysis computing system 100 is shown for performing conversation analysis and outputting, based on given inputs, different signals associated with selected conversations. Examples of implementations of the conversation analysis computing system 100 capable of implementing the described examples of FIG. 1 are discussed further with respect to the computing system of FIG. 8.

The conversation analysis computing system 100 includes a dashboard interface 102. The dashboard interface includes interface logic 104 and dashboard generator 106. The interface logic 104 and dashboard generator 106 are communicatively coupled in order to respond to requests implemented via a user interface 108. For instance, the interface logic 104 can include programmable code for parsing requests received via the user interface 108 and retrieve the corresponding data for output as display signals. Specifically, data retrieved according to interface logic 104 can be output by the dashboard generator 106, which may include programmable logic for causing the transmission of display signals associated with display on the user interface. The dashboard generator 106 can include pre-built interface services such as PowerBL, Grafana, and the like. Examples of specific dashboard interfaces caused to be displayed per the dashboard generator 106 are discussed further with respect to FIGS. 3-7.

Signals generated by the dashboard generator can be displayed via a user interface 108, for instance, the same interface which initiated the display request. The user interface 108 can include computing device capable of visual display of signals generated by dashboard generator 106 and/or for receiving display requests processed by interface logic 104. Examples of user interfaces 108 can include personal computers, mobile devices, and the like.

The conversation analysis computing system 100 is shown including a conversation database 110. The conversation database (also referred to as the enterprise data lake) can comprise any database capable of integrating and storing constituent databases. In preferred examples, conversation database 110 comprises a data lake environment, or other distributed computing environment system. Thus, while conversation database 110 is shown within the conversation analysis computing system 100, it is to be appreciated that the conversation database 110, in addition to other databases, may be stored external to the conversation analysis computing system, but otherwise communicatively coupled to, and accessible by, the conversation analysis computing system 100.

The conversation analysis computing system 100 may include multiple databases including a sanitized data repository 112 and a curated data repository 114. In some examples, such repositories 112 and 114 demarcate separate sections in the conversation database 110 when the conversation database 110 is in data lake environment. The sanitized data repository can itself comprise data retrieved from multiple constituent database including an engagement repository 118 and an interaction history repository 120. Such databases may preferably be divided to optimize the ingestion of respective data to form the sanitized data repository 112.

The engagement repository 118 includes display metrics associated with each conversation and pair of conversations as processed by an engagement engine 117. Examples of metrics stored in the engagement repository 118 include win-rate, overlap, presentment data, propensity data, priority data, and the like. The engagement repository 118 can include pair-wise comparisons for each conversation based on associated metrics, such as the win-rate between each conversation pair for a group of conversation pairs. Given that win-rate comparisons require analysis of conversation pairs, and that each combination of pairs of conversations may be analyzed via an engagement engine 117, the engagement repository 118 may then be decoupled from other data sources so as to optimize the processing speed for data to be stored in the engagement repository 118. Moreover, decoupling the data between the engagement repository 118 and the interaction history repository 120 allows for separate ingestion rates of the data as to be later ingested for storage in the conversation database 110.

The interaction history repository 120 can include further data and insights on each front-end user whose interactions via front-end devices 122 (i.e., mobile phones, computers, and other display interfaces) are recorded and logged within the conversation analysis computing system 100. Thus, when interaction history data from within the interaction history repository 120 is linked to the engagement repository 118, more granular levels of conversation data can be extracted from the conversation database 110. Examples of data stored in the interaction history repository 120 can include fact data and dimension tables outlining actions, channels, contexts, and outcomes related to conversations.

Ingestion, merging, and management of the various databases communicatively coupled to the conversation analysis computing system 100 can be managed by a database parser 116. The database parser 116 can comprise configurable logic for handling various database management operations according to various examples. For instance, the database parser 116 can be configured to set ingestion rates for various databases. The database parser 116 can set rates for periodic ingestion of data retrieved from the engagement repository 118 and the interaction history repository 120. According to some examples, the database parser 116 may be configured to ingest data from the engagement engine 117 at a more or less frequent rate as compared to data ingested from the interaction history repository 120.

Additionally, the database parser 116 can perform operations for merging data retrieved from the engagement repository 118 and the interaction history repository 120. For instance, each conversation and/or front-end user interaction may be assigned a unique key for allowing the linking and merging of data respective data files stored in each repository. In such a way, the database parser 116 logic can cause the merging of the data as to be stored in the conversation database 110.

### Example Process for Generating Metrics for Conversation Analysis

FIG. 2 shows a process for generating metrics for conversation analysis, according to certain examples. For illustrative purposes, the process 200 is described with reference to implementations described above with respect to one or more examples described herein. Other implementations, however, are possible. In some aspects, the operations in FIG. 2 may be implemented in program code that is executed by one or more computing devices such as the Conversation analysis computing system 100 of FIG. 1. In some aspects of the present disclosure, one or more operations shown in FIG. 2 may be omitted or performed in a different order. Similarly, additional operations not shown in FIG. 2 may be performed.

At block 202 the process 200 involves transmitting a set of conversations. Each conversation of the set of conversations can be transmitted to any combination of devices. For instance, multiple conversations can be transmitted to the same device, in addition to being transmitted to other devices. Generally, the devices receiving one or more conversations are front-end devices 122 (e.g., customer devices), where the conversations include prompts or other displays which can be interacted with within the front-end device 122.

Blocks 204-210 are shown performed for each conversation within the set of conversations. Thus, blocks 204-210 refer to “the conversation” as representative of a process applied to each conversation within a set of conversations.

At block 204 the process 200 involves tracking a set of display metrics associated with the conversation. Tracking display metrics can include receiving signals transmitted from the front-end devices 122, which may or may not be responsive to the conversation. Tracking display metrics can additionally include metrics generated by an engagement engine 117. For instance, display metrics can include eligibility data, indicating whether the conversation was eligible for presentment on a given device based on the device's associated user profile, decision data indicating whether the engagement engine 117 transmitted signals indicating that the conversation would be displayed on a given interface of a front-end device, presentment data indicating whether the conversation was displayed on the front-end device 122, and propensity data indicating whether the front-end device 122 engaged with the presented conversation. Data representing user interactions with conversations, referred to as user engagement data, can include propensity data, while data reflecting device and software interactions with the user, such as presentment data, can be referred to as interaction history data.

At block 206 the process 200 involves storing the set of display metrics. The set of display metrics can be stored in a first database, such as an engagement repository 118, prior to being ingested in a conversation database 110. As discussed with respect to FIG. 1, the conversation database 110 can be a cloud-accessible database such as a data lake environment, providing separate storage of sanitized data 112 and curated data 114. In some examples, the user engagement data, including sets of interaction metrics is retrieved via an engagement engine 117 and initially stored in an engagement repository 118 then subsequently ingested by a conversation database 110 per a database parser 116. The added buffer of the engagement repository 118 can provide for optimized means of retrieving data, by divorcing processing intensive display metric generation from conversation the database 110 which, according to some examples, requires real-time or near real-time interfacing.

At block 208 the process 200 involves pairing the conversation with another conversation within the conversation database. As block 208 of process 200 is performed for each conversation among the set of conversations, each conversation within the set of conversations will thus be paired with at least one other conversation. Additionally, in some examples, each conversation is paired with each other conversation within the conversation database 110 such that any pairing of conversations may be retrieved and analyzed per additional blocks of process 200.

At block 210, the process 200 involves generating a win-rate metric for the conversation pair based on the set of display metrics for each conversation. The win-rate metric, according to some examples can be determined based on display metrics, including the decision data and eligibility data. For instance, the win-rate for a given conversation can be based on the number of decisions (i.e., instances where the engagement engine 117 decided to render the conversation available for potential presentment), divided by the total number of eligible interactions. Each conversation in the pair may have its own win-rate, or may have a win-rate comparison relative to the paired conversation.

In some examples, in addition to a win-rate metric, the conversation analysis computing system 100 can further determine an overlap percentage. The overlap percentage can similarly be based on the display metrics including the eligibility data. The overlap percentage, according to some examples, can be determined based on the number of interactions where both conversations in the pair are eligible, divided by the total number of eligible interactions for the first conversation.

At block 212 the process 200 involves receiving a selection of a first conversation within the set of conversations. The selection may be received via a request input through the user interface 108. As an example, a developer or other back-end user may wish to analyze a selected conversation, (for instance, a conversation which they created) in order to determine the performance of the conversation against any other conversations similarly competing for display on a front-end user interface. In further examples, the conversation analysis computing system 100 can receive selection of a second conversation within the set of conversations. In such manner, the pair-wise data between the first conversation and the second conversation can be retrieved. Otherwise, absent selection of a second conversation, the conversation database 110 can automatically identify additional conversations for pair-wise comparison with the first conversation (i.e., based on degree of overlap between the conversations).

At block 214 the process 200 involves retrieving a set of conversation metrics associated with the first conversation. The set of conversation metrics include the win-rate metric for the first conversation and the second conversation. The conversation metrics can further include any form of analysis capable of being retrieved from the win-rate in addition to other display metrics and conversation metadata. Thus, display metrics retrieved from the engagement repository 118 can be retrieved.

In addition, the conversation metrics can include conversation metadata retrieved from an interaction history repository 120. The interaction history repository 120 can store interaction history data representing software interactions with user devices, including presentment data. Examples of conversation metadata can include the conversation channel type (i.e., whether presented on mobile devices, web-applications, or other mediums), and placement type (i.e., the means of display, such as a splash display, carousel display, banner display, and the like). Other conversation metadata can relate to the class the conversation belongs to. For example, a group type can identify the back-end users responsible for managing the conversation, or to what line of business the conversation may belong. The conversation metadata can include interaction history data.

Generally, the conversation metrics output for display can be configurable according to default rules and user requests. For instance, in some examples, the conversation analysis computing system 100 receives a selection of a second conversation for further analysis against the first conversation (e.g., to compare win-rates against the pair of conversations). In other examples, the system can provide a high-level summary of the selected, first conversation as compared against the conversation's closest competitors with regards to a variety of metrics such as rankings in overlap metrics, win-rates, propensity scores, value metrics, and priority scores. In other words, the set of conversation metrics retrieved may be selectable by a front-end user, configurable by a back-end user, or a combination of inputs from both sets of users. In such a way, front-end users can intuitively analyze the performance of the selected, first conversation.

At block 216 the process 200 involves transmitting a display signal associated with the set of display metrics. The dashboard generator 106 of the dashboard interface 102 may be configured to output the display signal. As discussed with respect to block 216, the set of display metrics is fluid and configurable per front-end user input and programmed logic (e.g., of interface logic 104). Thus, front end user metrics may differ according to various examples. Examples of such display metrics, as displayed are shown in FIGS. 3-7.

### Example Output Display Interfaces for Conversation Analysis

The generation of comparison metrics for conversations, in addition to the retrieval of linked metadata associated with each conversation allows for a variety of dashboards to be displayed, each providing a different perspective and level of analysis related to a given conversation or conversation pair. FIGS. 3-7 are provided to illustrate various dashboard interfaces for display, though it is to be appreciated that other displays and interfaces are contemplated within the scope of the described conversation analysis computing system.

FIG. 3 shows an interface for allowing conversation analysis, according to certain examples. The display dashboard 300 of FIG. 3, also referred to as the dashboard initial view, represents a potential initial display for presenting conversation analysis that can be implemented. The display dashboard 300 is shown including a conversation selection interface 302, date filter 304, and filters 306a-306d for manipulating the presentation of data as shown within the interface.

To use the interface, a user may first select the first conversation for analysis via the conversation selection menu. As shown, the selected conversation for analysis includes “upgrade X” with a conversation ID of 102. The selected conversation is then provided on a table for view and comparison against several additional conversations according to a variety of metrics.

The metrics for comparison, per display dashboard 300 include eligibility metrics, overlap percentages, decision count, presentment outcomes, win-rate metrics, and propensity scores. More or fewer display metrics may be selected for presentation on the display dashboard 300 and instead the particular configuration of metrics for display on the display dashboard 300 is shown to illustrate an example of analyses capable of being provided. Each of the display metrics on display dashboard 300 will now be described in further detail.

Eligibility refers to, out of all possible interactions, the number of interfaces that the interaction was actually able to be presented on, accounting for different exclusionary rules. For instance, regulatory rules, laws, and other compliance policies may prevent a given conversation from being presented on a given front-end device. If the front-end device is known as associated with a specific segment (e.g., the user is under 21 years old), different conversations (e.g., a home loan prompt) may be disqualified, or rendered ineligible, for presentment on the user device. Thus, a low eligibility metric can refer to a conversation that is frequently excluded from decisions for presentment due to a variety of factors including configured rules, strategies, legal or regulatory compliance, and the like.

Overlap refers to number of instances, or degree to which a pair of conversations are competing for a specific placement. Overlap requires the two conversations to both be eligible for presentment, and also for the two conversations to be decisioned. The two conversations need not have the same configuration, and rather may have some degree of overlap with respect to audiences which have been selected for each conversation. Thus, overlap provides the ability to further analyze each conversation competing in a specific placement to view overlapped audiences.

Decision count describes the number of instances in which a given conversation was selected for presentment across a set of devices. Decisions, as discussed throughout, can relate to the decision to place a message within a display, for instance within a banner, push notification, ribbon, or the like. Thus, a higher decision count for a given conversation indicates that the conversation is more often selected for presentment on a device than a conversation with a lower decision count. Higher decision counts can further indicate that the priority score of the associated conversation is higher that of other conversations that might also be eligible for presentment.

Decisions to present a conversation do not inherently mean that the conversation is displayed, but rather that the conversation was selected for display according to a given location or sub-interface within a front-end device 122. For instance, the decision to place a conversation within a banner may not lead to presentment of the conversation, depending on whether the banner is located in the app, or if the banner with the decisioned conversation is only visible subsequent to a user log in. Thus, the conversation may not be presented to the user in all instances where the conversation was otherwise decisioned for placement on a device. Presentment outcomes can therefore capture a metric distinct from the decision count, where the presentment outcomes are dispositions that occur based on customer behavior. Presentment outcomes indicate the conversation was actually displayed on a screen for user view. As presentment outcomes can only occur after a decision was made to present a conversation, positive presentment outcomes represents a subset of the decision.

Propensity values describe the likelihood that a front-end user is to engage with a conversation. Engagement can correspond to any kind of interaction with the conversation. For instance, engagement can relate to tapping a displayed banner conversation, responding via email to an email conversation, entering data into a prompt output with a conversation, and the like. The higher the propensity score, the more likely a front-end user has been determined to engage with the conversation. Propensity scores can be determined via past interactions with the conversation, and in some examples, may be determined in part via machine learning models trained on training data sets comprising previous engagement data related to conversations. Upon generation via machine learning models, the presentment outcomes may be stored as data values corresponding to a given conversation within the engagement repository 118, and then subsequently ingested by the conversation database 110 per the database parser 116.

The display dashboard 300 thus provides metrics corresponding to a selected first conversation, compared against several other conversations. For instance, the conversation selection interface 302 provides a drop down menu as an example means for selecting the first conversation for analysis. Other means for selecting conversations can be used, for example search bars, radio buttons, and the like. Once a user selects the first conversation per conversation selection interface 302, the display dashboard 300 is automatically updated to show the selected conversation (Here, Upgrade X with conversation ID 102), as conversation A, with comparisons against several other conversations B (where for instance, conversation IDs 804, 56, 89. . . each represent a conversation B for comparison with conversation A). Thus, the metrics as described above, such as eligibility scores, decisions, presentment, propensity and the like may be compared between conversations, where selected, desired conversation A provides the pivot for comparison against a set of other conversations. Additionally, relative pair-wise comparisons such as overlap and win-rate may be displayed for each conversation A-B pair. In such a way, metrics such as win-rate can reveal conversations that are outperforming or underperforming (e.g., based on number of decisions) when compared to a selected conversation.

In some examples, the displayed conversations B are automatically filtered according to greatest percentage overlap with the conversations B. Thus, upon selection of conversation A, the list of conversations B are automatically updated in order of descending degree of overlap. Additionally or alternatively, various filters 304, 306 may be included for further manipulation of the display. For instance, date filter 304 can allow users to select a given date for comparison, or a range of dates. Filters 306a-306d are shown to indicate a variety of other filters that may be applied according to the example display dashboard 300. For instance, filters 306a-306d can include channel, page name, placement, slot number, propensity decile, group, whether conversation A was presented, and the like. While four filters 306a-306d are shown, it is to be appreciated that there may be more or fewer filters 306a-306d according to various dashboard displays.

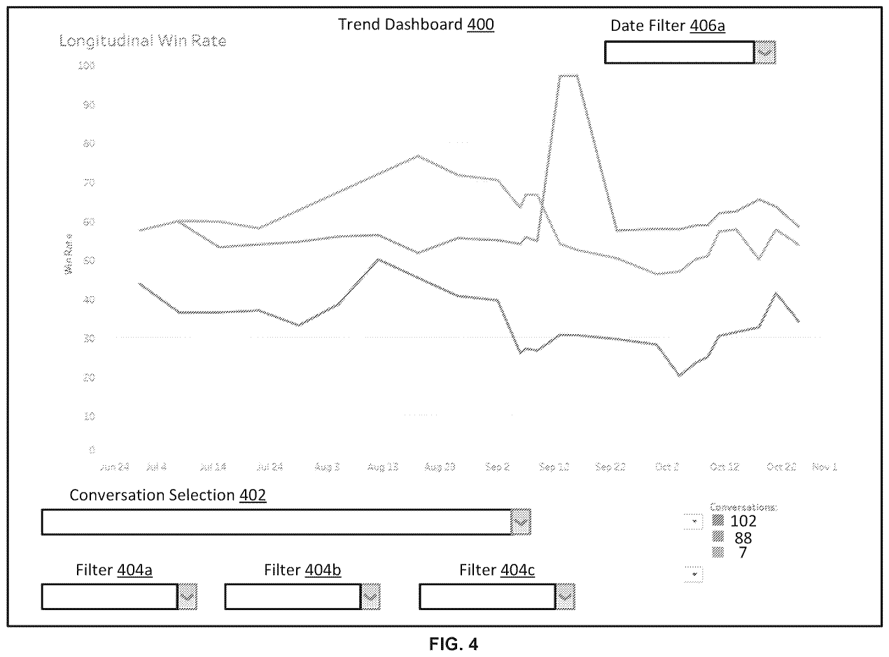

FIG. 4 shows an interface for allowing conversation analysis based on longitudinal win-rate, according to certain examples. The longitudinal win-rate display 400 of FIG. 4 illustrates the ability to let users compare the win-rate of given conversations over time and compare with competitors via a conversation selection interface 402. Similar to the display dashboard 300 of FIG. 3, users can manipulate various filters 404a-404c to analyze specific channels, pages, placement, groups, and the like. Additionally, the longitudinal win-rate display can provide win-rates at an aggregated level.

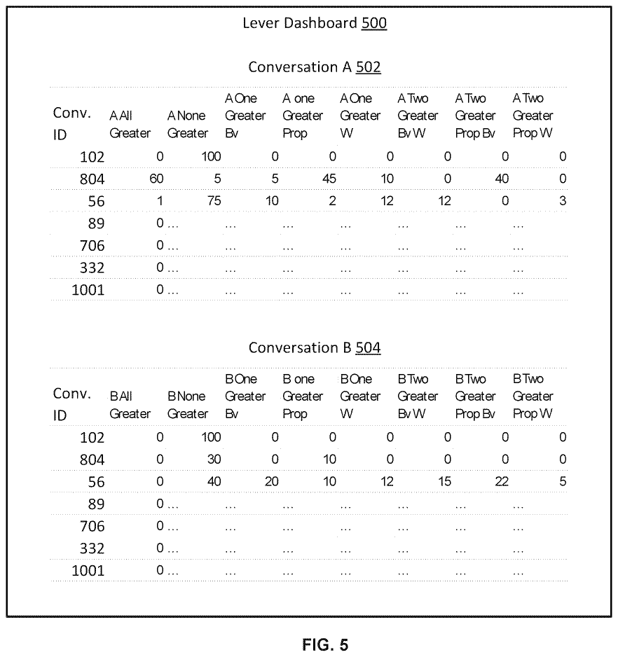

In some instances, it may be beneficial to analyze conversations based on underlying root causes, or levers. FIG. 5 shows an interface for allowing conversation analysis based on a set of levers, according to certain examples. In some interfaces, the decision to display a conversation is based on a priority score. The priority score can be determined based on a combination of factors such as strategy weight, potential value, and propensity scores. Strategy weight can relate to overarching goals or strategy that can be tuned and set by various back-end developers. Potential value can refer to another set of values which may be tuned and set by back-end users. In some instances, potential value can relate to financial value associated with the conversation. Propensity score, as discussed above, can refer to the likelihood of engagement with the presented conversation. As the priority score can be determined based on these, and potentially other configurations of factors, such factors can represent levers or root causes of behind the decision to display the conversation. Thus, according to the lever dashboard 500 of FIG. 5, each lever, or combination of lever can be displayed to illustrate how the conversations are determined.

The lever dashboard 500 can be separated by when selected conversation A wins (e.g., per conversation A table 502) and when conversation B wins (e.g., per conversation B table 504). Per each table, different scenarios and combinations of metrics for identifying when a conversation wins can be presented, including when all factors and scores of the conversation are greater, when a combination of two levers are greater (e.g., when the propensity score and strategic weights are greater, but the potential value score is not), or when only one lever is greater than the competitor conversation, yet the conversation still wins out over the other conversation (e.g., where only the propensity score is greater). While metrics including propensity score, potential value, prior, and strategy weight are shown, it is to be appreciated that any identified lever (i.e., metric factored into the priority score) or combination of levers can be displayed according to the tables within the lever dashboard 500.

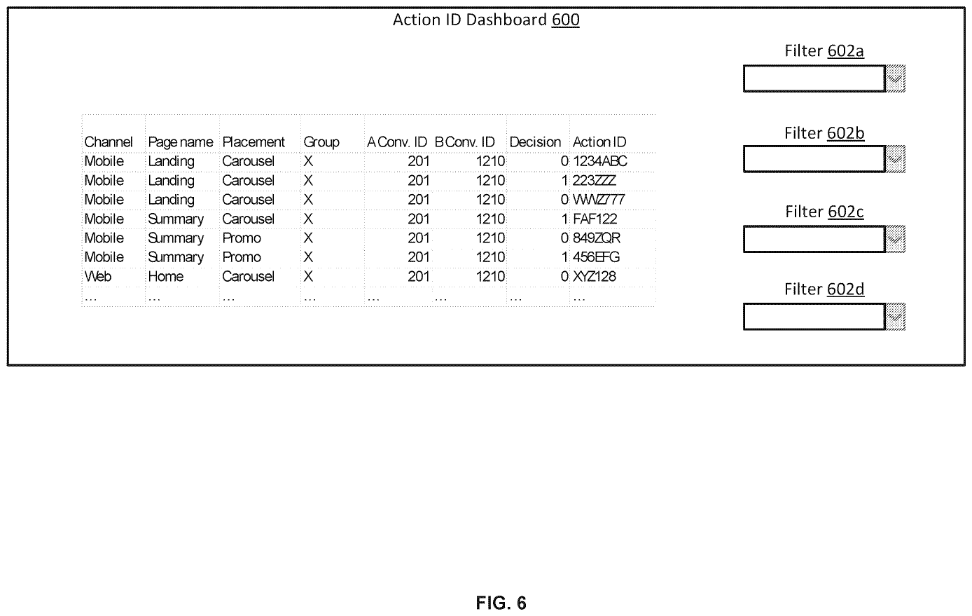

In some instances, it may be beneficial to analyze conversations based on underlying interactions at a front-end user level. FIG. 6 shows an interface for allowing conversation analysis based on user IDs, according to certain examples. Per the action ID dashboard interface 600 of FIG. 6, pairs of conversations may be selected (e.g., conversation ID 201 and 1210). Specific actions for each conversation may then be compared based on the action ID column. Additional columns provide further data related to the given action ID, including the channel displayed on, the page displayed on, the means of placement on the display, the group ID, and the like. As with other figures, filters 602a-602d are shown to illustrate means by which users may further tailor the analysis. Thus, per the action ID dashboard interface, action IDs can be collected and sampled for display. Such action IDs may be available for presentation according to various examples such as specific competing conversations, whether decisions and not decisions, and additional metadata such as channel, page name, placement, test group, date, and the like.

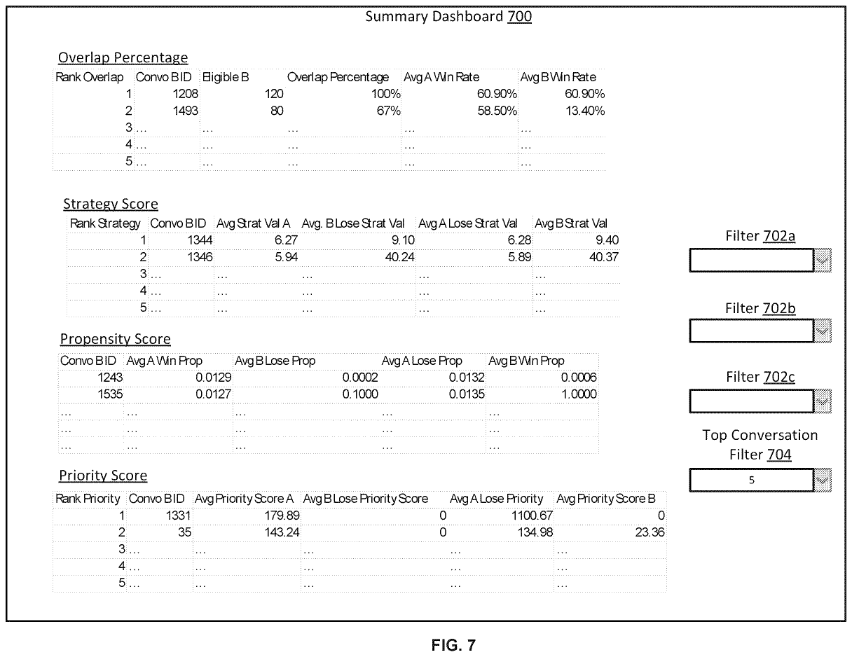

FIG. 7 shows an interface for allowing conversation analysis, according to certain examples. The interface 700 of FIG. 7, also referred to as the executive summary interface 700 can provide a quick summary view of a selected conversation's top competitors with regards to specific metrics. For instance, in the executive summary interface 700 of FIG. 7, the selected metrics include overlap percentage, strategy scores, propensity scores, and priority scores, each shown according to various tables displaying metrics for sets of conversations pairs, the tables including an overlap percentage table, a strategy score table, a propensity score table, and a priority score table. As with other figures, filters 702 may be included within the executive summary interface 700 providing the ability to filter on test group, channel page, placement, win-rate, and the like. Additionally, according to a top conversation filter 704, the number of top competitor conversations displayed can also be modified. For instance, in the example of FIG. 7, the top conversation filter 704 is set to the top 5 competitors; however, such values can thus be adjusted to increase or decrease the size of the top competitor group for further analysis.

### Example Computing Environment for a Conversation Analysis System

Any suitable computing system or group of computing systems can be used for performing the operations described herein. For example, FIG. 8 shows a block diagram for an example computing environment capable of executing the described systems and methods, according to certain examples.

The depicted example of a computing system 802 includes one or more processors 806 communicatively coupled to one or more memory devices 804. The processor 806 executes computer-executable program code or accesses information stored in the memory device 804. Examples of processor 806 include a microprocessor, an application-specific integrated circuit (“ASIC”), a field-programmable gate array (“FPGA”), or other suitable processing device. The processor 806 can include any number of processing devices, including one.

The memory device 804 includes any suitable non-transitory computer readable medium for storing the interface logic module 822, database parser 824, dashboard generator 826, and other dynamic instructions 828 or received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 802 may also include a number of external or internal devices such as input or output devices. For example, the computing system 802 is shown with an input/output (“I/O”) interface 808 that can receive input from input devices or provide output to output devices. A bus 808 can also be included in the computing system 802. The bus 808 can communicatively couple one or more components of the computing system 802.

The computing system 802 executes program code that configures the processor 806 to perform one or more of the operations described above with respect to FIGS. 1-7. The program code includes operations related to, for example, receiving and ingesting data files, generating metadata associated with the data files, determining access to the data files, or other suitable applications or memory structures that perform one or more operations described herein. The program code may be resident in the memory device 804 or any suitable non-transitory computer-readable medium and may be executed by the processor 806 or any other suitable processor. In some examples, the program code described above, including the interface logic module 822, database parser 824, dashboard generator 826, and other dynamic instructions 828 or received or determined values or data objects are stored in the memory device 804, as depicted in FIG. 8. In additional or alternative examples, one or more of the interface logic module 822, database parser 824, dashboard generator 826, and other dynamic instructions 828 or received or determined values or data objects described above are stored in one or more memory devices accessible via a data network, such as a memory device accessible via a cloud service.

The computing system 802 depicted in FIG. 8 also includes at least one network interface 812. The network interface 812 includes any device or group of devices suitable for establishing a wired or wireless data connection to one or more data networks 814 such as viewing applications 820 including user interfaces. Non-limiting examples of the network interface 812 include an Ethernet network adapter, a modem, and/or the like. A remote communication service 818 is connected to the computing system 802 via network 814 and can perform some of the operations described herein including generating templates or receiving messaging data and applying the messaging data to a specified template. The computing system 802 is able to communicate with one or more of the remote communication service 818 and data sources 816.

### Advantages of Systems and Methods for Conversation Selection Analysis

The described systems and methods provide improvements to techniques for analyzing and improving the efficacy of user interfaces. User interface interactivity faces several practical limitations. For instance, the size of a given screen, whether a mobile device screen or laptop screen, is bounded in the amount of information that can be displayed to a user. Moreover, the rate at which different conversations, or messages are provided to a user should be limited to avoid inundating the user and inhibiting the efficacy of such conversations. Thus, limited sets of data, or conversations, must be carefully selected in order to improve the user-interface experience. Traditional means selecting conversations lacked insight and transparency. The described conversation analysis system resolves such inefficiencies by providing greater clarity behind the internal logic of such conversation selection systems. Described techniques of generating metrics associated with conversations, pairing sets of conversations for further analysis, and merging data from repositories can thus allow for the implementation of improved user interfaces for electronic devices.

Additionally, the described techniques address optimized means for generating and storing data, allowing for the above described analyses. For instance, generating engagement data such as propensity scores, which may be machine learning generated, and further pairing such engagement data between records in order to display win-rate data, can require significant processing power, which risks over-burdening various computing systems with respect to processing time and other processing expenditures. Therefore, data sets, each pertaining to a different analysis of the set of conversations, may be segregated in order to improve computing efficiency. By segregating data sets, those data sets which are more computation heavy (e.g., per processing of an engagement engine) can be updated at different frequencies than lower profile data sets (e.g., those stored in an interaction history repository). Yet by linking such data sets together per subsequent ingestion, a complete view and analysis of each conversation can be provided at progressively more granular levels of detail, without sacrificing computational efficiency. Compared to prior techniques, the described procedures thus provide an improvement to computer functionality by enhancing computer processor resource utilization.

### General Considerations

Although the subject matter has been described in language specific to structural features or methodological acts, it is to be understood that the subject matter of any appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or any claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
transmitting a set of conversations;
for each conversation:
tracking a set of display metrics associated with the conversation;
pairing the conversation with another conversation;
generating a win-rate metric for the conversation pair based on the set of display metrics;
receiving a selection of a first conversation within the set of conversations; and
retrieving a set of conversation metrics associated with the first conversation, the set of conversation metrics including the win-rate metrics for the first conversation and a second conversation; and
transmitting a display signal associated with the set of conversation metrics.

2. The method of claim 1, wherein the set of conversation metrics includes an overlap percentage, a decision count, a presentment outcome, a propensity score, and a priority score.

3. The method of claim 1, wherein the set of display metrics are stored in a first database, and the method further comprises, for each conversation, retrieving a set of conversation metadata associated with the conversation from a second database; and
linking the set of display metrics to the set of conversation metadata to generate the set of conversation metrics.

4. The method of claim 1, wherein the set of display metrics include user engagement data representing user interactions with the set of conversations, and interaction history data representing software interactions with the user including presentment data.

5. The method of claim 4, wherein the user engagement data is tracked from an engagement repository and the interaction history data is tracked from an interaction history repository and wherein the user engagement data is stored in a data lake environment.

6. The method of claim 5, wherein the engagement repository is decoupled from the interaction history repository.

7. The method of claim 1, wherein transmitting the display signal causes a display interface to present an executive summary interface, wherein the executive summary interface comprises tables displaying metrics for a set of conversation pairs, the tables including:
an overlap percentage table comparing a percentage overlap between each conversation pair;
a strategy score table listing a strategy weight for each conversation within each conversation pair;
a propensity score table listing a propensity value for each conversation within each conversation pair; and
a priority score table listing a priority score for each conversation within each conversation pair.

8. A system comprising:
a memory device; and
a processing device coupled to the memory device, the processing device to perform operations comprising:
transmitting a set of conversations;
for each conversation:
storing a set of display metrics associated with the conversation;
pairing the conversation with another conversation;
generating a win-rate metric for the conversation pair based on the set of display metrics;
receiving a selection of a first conversation within the set of conversations; and
retrieving a set of conversation metrics associated with the first conversation, the set of conversation metrics including the win-rate metrics for the first conversation and a second conversation; and
transmitting a display signal associated with the set of conversation metrics.

9. The system of claim 8, wherein the set of conversation metrics includes an overlap percentage, a decision count, a presentment outcome, a propensity score, and a priority score.

10. The system of claim 8, wherein the set of display metrics are stored in a first database, and the operations further comprise, for each conversation, retrieving a set of conversation metadata associated with the conversation from a second database; and
linking the set of display metrics to the set of conversation metadata to generate the set of conversation metrics.

11. The system of claim 8, wherein the set of display metrics include user engagement data representing user interactions with the set of conversations, and interaction history data representing software interactions with the user including presentment data.

12. The system of claim 11, wherein the user engagement data is tracked from an engagement repository and the interaction history data is tracked from an interaction history repository and wherein the user engagement data is stored in a data lake environment.

13. The system of claim 12, wherein the engagement repository is decoupled from the interaction history repository.

14. The system of claim 8, wherein transmitting the display signal causes a display interface to present an executive summary interface, wherein the executive summary interface comprises tables displaying metrics for a set of conversation pairs, the tables including:
an overlap percentage table comparing a percentage overlap between each conversation pair;
a strategy score table listing a strategy weight for each conversation within each conversation pair;
a propensity score table listing a propensity value for each conversation within each conversation pair; and
a priority score table listing a priority score for each conversation within each conversation pair.

15. A non-transitory computer-readable medium storing executable instructions, which when executed by a processing device, cause the processing device to perform operations comprising:
transmitting a set of conversations;
for each conversation:
storing a set of display metrics associated with the conversation;
pairing the conversation with another conversation;
generating a win-rate metric for the conversation pair based on the set of display metrics;
receiving a selection of a first conversation within the set of conversations; and
retrieving a set of conversation metrics associated with the first conversation, the set of conversation metrics including the win-rate metrics for the first conversation and a second conversation; and
transmitting a display signal associated with the set of conversation metrics.

16. The non-transitory computer-readable medium of claim 15, wherein the set of conversation metrics includes an overlap percentage, a decision count, a presentment outcome, a propensity score, and a priority score.

17. The non-transitory computer-readable medium of claim 15, wherein the set of display metrics are stored in a first database, and the operations further comprise, for each conversation, retrieving a set of conversation metadata associated with the conversation from a second database; and
linking the set of display metrics to the set of conversation metadata to generate the set of conversation metrics.

18. The non-transitory computer-readable medium of claim 15, wherein the set of display metrics include user engagement data representing user interactions with the set of conversations, and interaction history data representing software interactions with the user including presentment data.

19. The non-transitory computer-readable medium of claim 18, wherein the user engagement data is tracked from an engagement repository and the interaction history data is tracked from an interaction history repository and wherein the user engagement data is stored in a data lake environment.

20. The non-transitory computer-readable medium of claim 15, wherein transmitting the display signal causes a display interface to present an executive summary interface, wherein the executive summary interface comprises tables displaying metrics for a set of conversation pairs, the tables including:
an overlap percentage table comparing a percentage overlap between each conversation pair;
a strategy score table listing a strategy weight for each conversation within each conversation pair;
a propensity score table listing a propensity value for each conversation within each conversation pair; and
a priority score table listing a priority score for each conversation within each conversation pair.
